(19) United States
(12) Patent Application Publication
(10) Pub. No.: US 2007/0284785 A1
(43) Pub. Date: Dec. 13, 2007

(54) Device, System and Method for Cutting, Cleaving or Separating a Substrate Material

(75) Inventor: Brian Hoekstra, Scottsdale, AZ (US)

Correspondence Address: SMITH PATENT OFFICE, 1901 PENNSYLVANIA AVENUE N W, SUITE 901, WASHINGTON, DC, 20006, US

(73) Assignees: Applied Photonicss, Inc.; Toray Engineering Co., Ltd.

(21) Appl. No.: 11/630,165

(22) PCT Filed: Jun. 20, 2005
(86) PCT No.: PCT/US05/21930

§ 371 Date: Dec. 20, 2006

Related U.S. Application Data
(60) Provisional application No. 60/581,856, filed on Jun. 21, 2004.
(60) Provisional application No. 60/582,195, filed on Jun. 22, 2004.

(51) Int. Cl. B29C 37/00

(52) U.S. Cl. 264/400; 425/142; 425/174.4

(57) ABSTRACT

An apparatus and method for separating a nonmetallic substrate is disclosed as including a first beam; a first quenching device positioned so that a coolant stream may be applied to the substrate at or immediately adjacent to the trailing end of the first spot; a second beam; and a second quenching device positioned between the first quenching device and the second beam. At least one of an angle at which the first scribe beam impinges on the substrate and an energy intensity of the first scribe beam impinging on the substrate are adjusted to obtain right angle separation. A crack sensor and controller can also be provided for measuring a position of the cut line, comparing the position with a reference position and adjusting the power intensity of the second beam based on the comparison of the position of the cut line with the reference position.

### CROSS REFERENCE TO RELATED APPLICATIONS

This application claims the benefit of U.S. Provisional Application No. 60/581,856 filed Jun. 21, 2004 and U.S. Provisional Application No. 60/582,195 filed Jun. 22, 2004, and hereby incorporates these applications herein by reference.

### BACKGROUND OF THE INVENTION

1. Field of the Invention

The present invention generally concerns cutting and separating technology. More particularly, the present invention involves a device, system and method for cutting, cleaving, and/or separating nonmetallic or brittle materials using lasers.

2. Discussion of the Related Art

The technique of propagation of a microcrack in a brittle material using a laser has been known for more than three decades. U.S. Pat. No. 3,610,871 issued to Lumley in 1971, is an early well known disclosure. Despite prolific activity, this technique has not yet become commercially viable for many applications. The primary reasons for this situation are slow process speeds, use of complicated laser modes, poor understanding of laser scribing mechanisms, and time consuming, archaic two-step processes (e.g. scribe and break) which generate particulate and microcracks and thus counteract a primary advantage of laser separation.

There are two primary mechanisms that need to be understood in order to design an optimum system for separating non-metallic materials. The first mechanism is a thermal mechanism whereby the brittle material exceeds its critical thermal shock temperature by elevating the temperature of the material to a desired level and then rapidly quenching the material to break the molecular bonds within the material. This process forms what is commonly called a “blind crack” in the material caused by internal thermal variations, external forces, internal forces, and edge strength of the material. The second mechanism is the three-dimensional stress/strain field relationship within the material caused by internal thermal variations, external forces, internal forces, and strength of the material.

U.S. Pat. No. 5,826,772 discloses a prior method for breaking a substrate that does not fully separate the boundaries.

The standard techniques for separation require a two step process to break the material, namely, a scribe step followed by a mechanical breaking step. This is especially true if the substrate thickness is greater than 0.4 mm and thus the residual tensile forces in the substrate are not sufficient to separate the substrate.

Other techniques use dual break beams that are too wide, usually >8 mm causing thermal shock on the perimeter of the intended cut. This leads to weakening and/or uncontrolled cracking of the glass. Also, there are many cases when the separation has to occur within a limited path width due to the presence of electronic devices or coatings/layers on either side of the cut.

U.S. Pat. Nos. 6,259,058; 6,489,588 and 6,660,963, invented by the present inventor, all disclose devices and methods for separating nonmetallic substrates using two laser beams and a quenching nozzle adjacent to the laser beams. These patents are hereby incorporated by reference.

Additional items that need to be addressed to improve on these devices are discussed below.

Exceeding the Thermal Rupture Temperature—In order to propagate a microcrack through a brittle material, one must exceed the critical thermal shock temperature (Tcr) or point at which the molecular bonds in the material break to form a blind crack within the material. This is normally accomplished by heating the material to a given temperature and quenching the material using a coolant stream to exceed the critical thermal shock temperature (Tcr). For some materials, Tcr is minimal and thus relatively little quenching is required to successfully propagate a microcrack. In these cases, a cooling gas alone, such as Helium, can be used for quenching. For other materials, especially those with low thermal expansion coefficients, a high gradient is required to exceed Tcr and thus a gas/water mixture is required for effective quenching. In this case, the latent heat release from the evaporation of the liquid combined with convective and conductive heat transfer serves to quench the material in a more efficient manner thereby exceeding the critical thermal rupture temperature.

However, even with optimized quenching, proper initial boundary conditions are required to successfully achieve laser scribing. In other words, the temperature of the material needs to be elevated to a point high enough to give the quenching “room” to exceed the critical thermal rupture temperature. Often, the process window between the minimum temperature and the maximum temperature (e.g. softening temperature for glass) is very small and thus precise control of the heat affected zone is required.

Exceeding the Critical Breaking Force—Traditional scribing operations typically require a second break step after the initial vent or blind crack is formed in the material. In this case, mechanical methods for completing the break are utilized whereby a bending moment is employed using mechanical methods such as roller breaker tools or mechanical guillotine breaker tools. In each of these methods, a sufficient force is applied to complete the separation of the material along the scribed area. The force required to effect full separation is herein referred to as the Critical Breaking Force (Fcb). When scribing thin material (e.g. less than 0.4 mm), the residual tensile forces in the material may be sufficient enough to separate the glass. However, the residual tensile forces are not as controllable as the new methods described herein. It is therefore desirable to minimize the residual tension forces of the scribe process in favor of more controllable approaches. For thicker material, the residual tensile forces from the laser scribing operation are not usually sufficient to fully separate the material. In other cases, the tensile forces are so great that the material separates in an uncontrollable manner and can move well ahead of the quenching region. This results in a compromise in straightness since the separation dynamics are controlled by thermal gradients alone which are, by nature, asymmetric. Some techniques have suggested using dual parallel beams without quenching as a separation mechanism. However, these techniques lead to irregular cuts due to inherent asymmetries. New methods are needed to improve control over the Critical Breaking Force.

Overcoming Edge Effects—One important consideration is the entry and exit crack in any given material. The edge of a substrate is much weaker than the bulk of the material thus making it susceptible to uncontrolled cracking after introducing thermal shock. In addition, there are often microcracks present along the edge of a material due mechanical processes such as edge grinding which need to be considered as well. Finally, the edge of the material tends heat up faster than the bulk of the material since the edge serves as a boundary between conductive and convective heat transfer regions. Therefore, a method for overcoming edge effects such as intrusions and extrusions needs to be improved.

Reliable Scribe Initiation—In order to propagate a microcrack through a material, an initial microcrack needs to be present. As mentioned, many materials already have an abundance of microcracks along the edge due to other processes. However, it is more desirable to introduce a microcrack in a controlled manner at a given location than to rely on residual microcracks. In addition, as edge treatment techniques improve, it becomes more difficult to initiate a microcrack along an edge since these edges are engineered to withstand cracking. Thus, reliable scribe initiation techniques are needed.

Effective Crosscutting—Full separation technology presents new challenges. Once a substrate has been fully separated in one direction, making cuts in a second direction (usually 90 degrees) becomes more challenging due to the presence of numerous new boundaries.

Further, the laser beam delivery systems that require multiple optical elements offer little flexibility in design. In addition, multiple optical elements absorb or reflect a significant amount of the laser power (e.g. 5% per element for AR coated ZnSe elements) resulting in a loss of more than 36% when using a 6 element system. In addition, complex optical systems are massive and difficult to move. Furthermore, these complex systems require precise alignment and calibration that can easily be jarred out of place. Finally, the critical distances such as those between the quenching nozzle, the scribe beam, the break beams, and scribe initiation are difficult to adjust and not very stable.

Most systems can only accomplish unidirectional cutting due to the large mass of the beam delivery system and independent control of the other elements such as the scribe initiation and the quenching device.

Typically, there is only room for one laser head unit per machine thereby removing the option of placing multiple heads that cut simultaneously to save time in manufacturing.

Fixed optical systems also require almost twice the equipment footprint due to the inherent inefficiencies required to move the work piece under the laser beam instead of having the laser move to the work piece.

Also, the distance between the scribe and break beams is fixed in prior designs and the footprint of the entire assembly is limited to a finite width. This does not allow for much flexibility when changing to different materials.

The relative beam power between the scribe and the break beams is regulated by physically changing a beam splitter or adjusting a faceted element. With a beam splitter, the relative power is a function of the coating on the beam splitter and is difficult to reproduce.

Further, the nozzle design leads to inconsistent flow and can leave water or other liquid residue on the work piece.

Thus it can be seen that there are numerous problems and many techniques have disadvantages from to be overcome in this field.

### SUMMARY OF THE INVENTION

To overcome these and several other disadvantages, the present invention uses several innovative techniques that provide for fast, reliable laser scribing, single step separation, and efficient implementation into a device that is simple yet powerful.

This invention generally relates to precision separation of non-metallic materials into a plurality of smaller pieces. In particular, the invention relates to a method for precisely controlling the splitting of non-metallic materials by the controlled propagation of a microcrack and internal forces of the material to affect full separation along a desired path.

One object of this invention is to match optimum thermal conditions for consistent and controllable thermal cracking (e.g. “laser scribing”) with optimum stress/strain field conditions to fully separate a non-metallic material in a prescribed, controlled manner.

A further object of the invention is to separate a substrate in a controlled manner by applying a large enough force (Fcb) at an appropriate location behind the quenching region while keeping the residual forces below the critical breaking force (Fcb) in front of the quenching region.

Major Components—The main components of the full separation laser system include single or multiple laser sources, a motion system designed to move the work piece relative to the optical system, an optical system comprised of two (or more) beam paths, an integrated cleaving device, a laser scribe acceleration device, and a supplemental breaking device.

Laser source—The laser source needs to be chosen based on the material to be separated. The primary criteria for scribing is to find a laser source that is efficient, reliable, and most importantly, has an output wavelength with an absorption coefficient close to 100%. That is to say, the laser radiation should be absorbed primarily at the surface of the material to be separated. In the case of glass, a CO₂ laser source with an output frequency of 10.6 microns is typically used. In the case of silicon, a YAG laser source with an output frequency of 1.06 microns or less is typically used. In addition, the operational mode of the laser should be the TEM₀₀ mode, which provides a beam profile that is predominately Gaussian in shape. When using an optical system, it is important to achieve a uniform collimated output so that the laser beam profile does not appreciably change from one point to another. It is also advisable to provide enough space between the output of the laser and the flying optics to give the laser beam time to transition to what is commonly known as “far field” conditions.

In the case of the LSAD beam path, the selection of the laser output frequency does not necessarily have to correspond with maximum absorption efficiency. In some cases it may be desirable to select a laser frequency significantly less than 100% to allow for heating throughout the body of the material. This serves to efficiently heat the bulk of the material in the region of interest while limiting tensile forces and radiative heat loss at the surface. Also, it is important to achieve the same collimation criteria mentioned herein.

Finally, there are cases where one may want to mix different laser frequencies within the same region or beam spot. For example, a laser may be used to preheat a material at a frequency that is highly absorbed to allow it to be subsequently heated by a laser of differing frequency that would normally not be highly absorbed. This phenomenon occurs due to the increased temperature dependent absorption or free carrier absorption.

Motion system—A motion system using a computer to control the movement of the work piece relative to laser output is used. There are a number of methods that can be employed to accomplish this. One method involves moving the work piece in the x, y, and Θ directions while the optics remains stationary. Conversely the work piece can remain stationary while the optical system is moved in every direction. A hybrid approach can also be taken wherein both the optical system and the work piece can be moved in limited directions. In addition, rotating, the optical system 180 degrees can be employed for bi-directional cutting. Another option is to utilize a multiple ICD array for production use to save time. In this case, the desired ICD can be moved into the beam path at the appropriate time. These opinions become more viable as the optical system becomes simpler and less massive. Finally, one can cut on both the top and bottom side of the material by putting the work piece on a process table with slots underneath the desired cuts.

This type of process table also serves to facilitate breaking with a roller breaking device placed underneath the workpiece.

Integrated Cleaving Device (ICD)—The optical path, quenching mechanism, optional shutter, and water removal are integrated into a single, versatile device. This device is designed to be simple and flexible allowing the user to achieve the desired high thermal gradients in a material. A triple, reflective quenching mechanism (TRQM) is utilized to provide for controlled high temperature gradients in a substrate.

The nozzle can be fitted with a reflective cover to redirect the laser beam around the nozzle and cause a portion of the laser beam radiation to impinge on the work piece near, adjacent to, intersecting, around or within the quenching region.

A custom single element lens can be used in the ICD for laser scribing which makes the design much more efficient and flexible. The use of a single element significantly reduces the size and weight of the laser head. A preferred embodiment uses a Double Asymmetric Cylinder Lens Element (DACLE). The DACLE can be used to efficiently achieve the desired laser beam profile.

A microcrack initiator (MI) is placed directly on the ICD housing and involves placing a standard scribe wheel in a z stroke mechanism to create a microcrack on the edge of the material to be separated. The MI is placed before the scribe beam. The MI is placed after the Laser Scribe Acceleration Device (LSAD) to reduce the chance that the heat generated by the LSAD will prematurely begin propagating a microcrack. The present invention also incorporates a Laser Scribe Initiation option using ablative YAG pulses at the surface of the glass.

The integrated cracking device is comprised of a single tube, either circular or square in cross-section containing a single custom optical element, microcrack initiator, quenching device, and mirror element.

Optical Element—The single optical element is designed to provide an optimal thermal footprint that is, in general, an elliptical beam no greater that 80 mm long and no wider than 5 mm. It is also desirable for this element to exhibit a flat top profile in each direction. There are a number of ways to achieve this profile from a single element given a collimated input beam. One way is by using a diffractive optical element whereby the internal structure of the lens is altered to provide a preprogrammed output profile. Another, less expensive way to achieve this desired profile is by utilizing a Double Asymmetric Cylindrical Lens Element (DACLE). The curved “concave” surface (S1) is designed to provide the optimum negative focal length and controls the beam length (l) and energy distribution in the direction of the cut (x). The opposite curved “convex” surface (S2) is designed to provide the optimum positive focal length and controls the beams width (w) and its energy distribution orthogonal to the cut direction (y). The curved surfaces are programmed to provide an output that will be optimal for cutting.

The nozzle assembly has three distinct fluid systems that are designed to provide efficient quenching. In a preferred configuration, a liquid is channeled through the middle tube, a gas is directed through a co-axially outer tube and a vacuum is applied to the outermost region. In this configuration, high pressure air serves to dynamically channel the liquid toward the center of the quenching region while the vacuum removes any residual liquid and controls the air flow. An optional high frequency piezo-electric transducer can be placed on the nozzle to help break up and atomize the water to improve quenching efficiency. In the preferred configuration, the vacuum is not coaxial with the nozzle but placed in the back half of the nozzle assembly relative to the motion of the table.

Partial Shutter Mechanism—A shutter placed between the custom lens element and the work piece can be used to selectively block a portion of the laser radiation to effectively shorten the beam spot on the work piece. This feature can be utilized to change the beam length during the laser cutting process to achieve a desired affect. For example, the shutter can be employed to truncate a front section of the laser beam while the laser beam is near the leading or trailing edge of the substrate to avoid overheating the edges. This may also be accomplished by changing the focal distance in real time using motorized lens holders.

Breaking device—Full separation of substrates is accomplished using a variety of techniques including, 1) chilling the bottom surface of the substrate, 2) heating the top of the substrate using a stream of hot air, dual laser beams, a single laser beam, or a single laser beam operating in the TEM₂₀ mode, 3) mechanically stressing the substrate in the desired manner utilizing innovative features built into a process table, 4) an inverse roller breaking device to create the desired compressive/tensile force in the substrate, and 5) Shear force separation techniques for laminated glass to eliminate or reduce microcracks.

In addition, a roller breaking device can be positioned underneath the substrate and moved along the path of the cut a given distance behind the scribe area to effect full separation. This works the best if the process table has slots underneath the intended cut. The advantage to this technique is that the force is placed well behind the scribe area thereby ensuring straightness. Finally, one can utilize shear forces to separate substrates which is especially useful for laminated materials. This will help minimize or reduce microcracks in the middle layer of a laminate by eliminating the bending moment introduced by the other techniques mentioned above.

Besides the TRQD discussed above, the present invention is also directed to a quenching device that includes at least two nozzles. The first quenching nozzle is primarily used to keep straightness for the laser scribe. The first nozzle can use either one or two fluids and an injection nozzle or an atomizing nozzle. The first fluid is typically a liquid such as water. The quantity of the first fluid and the fluid pressure can both be adjusted. The second fluid can be air, nitrogen, a mixture of oxygen and nitrogen, and a mixture of oxygen, nitrogen and carbon dioxide. The quantity of the second fluid and the fluid pressure can both be adjusted. The fluid quantity can be adjusted by varying the orifice size or by using a regulator. Types of regulators include a needle valve, a venturi valve, a butterfly valve, a gate valve and so on. There is a small spot for the quenching area. Further, the focusing distance of the mist is the same as the cutting.

The second nozzle allows a shallow vent to be made deeper. The second nozzle can include parameters which are independently adjustable from the first nozzle. The spot size of the second nozzle stream is wider than the spot size produced the first nozzle. Also, the focusing distance of the mist is different with the cutting.

Another issue that is addressed by the present invention is related to the term “soge” (or orthogonality) and refers to the fact that the cut edge is not a perfect right angle cut throughout the material. To overcome this soge problem, the angle of the cut edge needs to be as close to a right angle as possible. The present invention can adjust the major axis along the cut line and the energy intensity. The energy intensity is changing the heat affected zone from tip to tail and/or right to left. The heat transmission for the cross direction at the cut line is adjustable from the beginning part to the end part. The energy intensity can be adjusted by the beam position. The beam position is adjusted by the optics and/or table position. This includes adjusting the lens position, the position of the reflection mirror and the angle of the reflection mirror. The energy intensity can also be adjusted by the beam angle. The beam angle can be adjusted by the lens angle and/or the table angle.

The present invention also relates to a cutting method that allows single glass pieces and laminated glass pieces to be cross cut in at least two directions. One method disclosed uses the laser beams to create a cross section at each cut line which leaves the glass piece unseparated. The first cut line can be a half cut so that it cuts through approximately half of the glass piece and the cut line in the second direction can be a full cut. The cut line in the first direction is a half cut in front and behind 45 mm at the cross section. The half cut depth can be adjusted by changing the irradiated heating energy. It is also possible to make a serrated vent using a downward force, such as with a vacuum suction being applied. Another way to make the serrated vent is by balancing the heating energy with the downward force.

The present invention also relates to a method and device for separating nonmetallic substrates by using a crack sensor. This allows the laser power of the break beam to be optimized and a good cutting plane can be obtained. The crack sensor is positioned near the substrate so that it can dynamically measure the position of the cut line generated in irradiation of the break beam. The measured position information of the crack is then compared with a reference position and a means is provided to adjust the power intensity of a break beam based on this comparison. The crack sensor can be a CCD sensor, a CMOS sensor, an acoustic sensor, an image sensor or an ultrasonic sensor. The comparison between the measured crack position and the reference position is done by the signal processing device, an operation treating substrate and a microprocessor. It is possible to increase the beam energy if the cracking position is behind the reference position and decrease the beam energy if the cracking position is leading the reference position.

The present invention also relates to a method and device for adjusting the shaped of the scribe laser beam away from a symmetrical shape in the cutting direction. The method allows the beam shape or energy intensity to be asymmetrical between the front and back sides. For example, the beam width of the beginning part for heating is wider and the ending part is narrower. Alternatively, the beam width of the beginning part for heating is narrower and the ending part is wider. The beam energy power can be made higher or lower in a particular area. These features can be accomplished by changing the density of the beam intensity. It is also possible to provide a tilt angle to the beam irradiation. This tilt angle can be defined between the substrate and the irradiated beam direction. The lens angle can also be adjusted so that it is tilted relative to the irradiated beam direction.

Using these techniques described above it is possible to accomplish another object of the present invention which is to provide a method and apparatus that separates non-metallic materials through highly controlled propagation of a microcrack and precision splitting which overcomes the disadvantages of the prior art. Thus the present invention includes features to enable fast process speeds with full separation, increased accuracy, highly controlled thermal gradients, improved edge quality, effective crosscutting, reduced edge effects, and a simplified design providing for more flexibility and reduced cost.

These and other objects of the invention are accomplished by an apparatus for separating a portion of a nonmetallic substrate, comprising a first beam, the first beam impinging on the substrate at a first spot, the first spot having a leading end and a trailing end; a first quenching device, the first quenching device positioned so that a coolant stream may be applied to the substrate at or immediately adjacent to the trailing end of the first spot; a second beam, the second beam impinging on the substrate at a second spot, the second spot positioned on the substrate behind the first spot; and a second quenching device, the second quenching device positioned between the first quenching device and the second beam. It is also possible to use a third quenching device positioned between the second quenching device and the second beam. The quenching devices can include at least one device including an atomizing nozzle having a two fluid mixture, such as water and air. The control of the separating device also includes independently adjusting the parameters of the first quenching device relative to the second quenching device (or third quenching device).

The present invention is also accomplished by a method of controlling separation of a portion of a nonmetallic substrate, comprising the steps of impinging a first beam on the substrate at a first spot, where the first spot has a leading end and a trailing end. Then quenching with a first quenching nozzle positioned so that a coolant stream may be applied to the substrate adjacent to or spaced from a heat affected zone. Further quenching is also done with a second quenching nozzle positioned adjacent to and spaced from the first quenching nozzle. Next a second beam impinges onto the substrate at a second spot to break through a portion of a thickness of the substrate. The method can also include providing additional quenching with a third quenching nozzle positioned adjacent to and spaced from the second quenching nozzle. Following the quenching process, the excess quenching liquid is vacuumed up prior to the substrate portion reaching the second spot. It is also possible to control and vary an amount of power supplied in the second beam.

The present invention is also accomplished by a method of making a right angle separation in a nonmetallic substrate, comprising the steps of impinging a first scribe beam on the substrate at a first spot, where the first spot has a leading end and a trailing end. Then quenching with a first quenching nozzle positioned so that a coolant stream may be applied to the substrate in a heat affected zone. Following quenching, a second beam impinges onto the substrate at a second spot to break through a portion of a thickness of the substrate. The method also includes adjusting at least one of an angle at which the first scribe beam impinges on the substrate and an energy intensity of the first scribe beam impinging on the substrate. The adjusting step also includes adjusting a position of a lens related to the first scribe beam and/or adjusting a position of the first spot (for example, by adjusting a position of a table holding the substrate or a mirror).

The present invention is also accomplished by a method of separating a nonmetallic substrate, comprising the steps of impinging a first beam on a first side of the substrate at a first spot and then quenching with a first quenching nozzle positioned so that a coolant stream may be applied to the first side of the substrate. A second beam is then impinged onto the substrate at a second spot to break through a portion of a thickness of the substrate. The substrate is then rotated so a second side of the substrate is facing the first beam, the first quenching nozzle and the second beam. The first beam subsequently impinges on the second side of the substrate at a third spot and then quenching is performed with the first quenching nozzle positioned so that a coolant stream may be applied to the second side of the substrate. The second beam then impinges onto the substrate at a fourth spot to break through at least another portion of the thickness of the substrate. The method can also include quenching with a second quenching nozzle positioned between the first quenching nozzle and the second beam. Also, the step of impinging a second beam onto the substrate forms an approximately half cut through the first side of the substrate and the step of impinging the second beam onto the second side of the substrate forms a full cut through the substrate.

The present invention is also accomplished by an apparatus for separating a portion of a nonmetallic substrate including a first beam impinging on the substrate at a first spot, a first quenching device so that a coolant stream may be applied to the substrate at or immediately adjacent to the trailing end of the first spot, a second beam impinging on the substrate at a second spot positioned on the substrate behind the first spot for forming a cut line in the substrate, a crack sensor separated from the substrate for measuring a position of the cut line, and a controller operatively connected to the crack sensor for receiving information about the position of the cut line and comparing the position of the cut line with a reference position, and the controller includes means for adjusting the power intensity of the second beam based on the comparison of the position of the cut line with the reference position. The crack sensor can include at least one of a CCD sensor, a CMOS sensor, an acoustic sensor, an image sensor and an ultrasonic sensor. The means for adjusting and controlling the power intensity of the second beam includes decreasing the power intensity if the cracking position is ahead of the reference position and increasing the power intensity if the cracking position is behind the reference position.

The present invention is also accomplished by a method of adjusting a separation process of a nonmetallic substrate, comprising the steps of impinging a first beam on the substrate at a first spot, quenching with a first quenching nozzle positioned so that a coolant stream may be applied to the substrate in a heat affected zone, impinging a second beam onto the substrate at a second spot to break through a portion of a thickness of the substrate thereby forming a cut line in the substrate, measuring a position of the cut line using a crack sensor, comparing the position of the cut line with a reference position, and adjusting the power intensity of the second beam based on the comparison of the position of the cut line with the reference position.

The present invention is also accomplished by a method of adjusting a beam shape during a separation process of a nonmetallic substrate, comprising the steps of impinging a first beam on the substrate at a first spot, quenching with a first quenching nozzle positioned so that a coolant stream may be applied to the substrate in a heat affected zone, impinging a second beam onto the substrate at a second spot to break through a portion of a thickness of the substrate thereby forming a cut line in the substrate, and adjusting at least one of a shape of a first spot where the first beam impinges on the substrate and an energy density profile of the first beam so that there is a varying energy density profile of the first beam impinging on the substrate. The adjusting step can be accomplished by adjusting the shape of the first spot to include an asymmetrical beam shape, adjusting the energy density profile of the first beam so that there is an asymmetrical energy density or that a center of the energy density profile is closer to one side of the first spot than another side. The step of adjusting also includes forming one portion of the first spot to be thinner than another portion of the first spot or forming a tilt angle between the substrate and a direction of the first beam, such as by adjusting a lens position forming the first beam.

The present invention is also accomplished by an apparatus for adjusting a beam shape during separation of a nonmetallic substrate, comprising a first beam impinging on the substrate at a first spot, a first quenching device positioned so that a coolant stream may be applied to the substrate at or immediately adjacent to the trailing end of the first spot, a second beam impinging on the substrate at a second spot positioned on the substrate behind the first spot for forming a cut line in the substrate, and a controller means for adjusting a shape of the first spot produced by the first beam. The controller can include a means for adjusting the shape of the first spot into an asymmetrical beam shape or a means for adjusting the energy density profile of the first beam into an asymmetrical energy density. The controller can also include a means for adjusting the energy density profile of the first beam so that a center of the energy density profile is closer to one side of the first spot than another side. The controller can also include a means for forming one portion of the first spot to be thinner than another portion of the first spot and a means for forming a tilt angle between the substrate and a direction of the first beam by adjusting a lens position forming the first beam.

### BRIEF DESCRIPTION OF THE DRAWINGS

The above and other objects and features of the present invention will be clearly understood from the following description with respect to the preferred embodiment thereof when considered in conjunction with the accompanying drawings and diagrams, in which:

FIG. 1 is a schematic drawing showing a nonmetallic substrate being separated by a separating apparatus according to an embodiment of the present invention.

FIG. 2 is a schematic top view showing the heating regions and quenching regions formed respectively by the laser beams and quenching nozzles according to the present invention.

FIG. 3 is a time vs. temperature graph showing the heating, quenching and reheating phases during separation of the nonmetallic substrate.

FIG. 4 is a perspective view of the separating apparatus according to an embodiment of the present invention.

FIG. 5 is an enlarged fragmentary view of the double asymmetric cylinder lens element that is contained within an integrated cracking device according to an embodiment of the present invention.

FIGS. 6A-6D show schematic views of a nonmetallic substrate separation apparatus including views showing controlling a cleave depth according to the present invention.

FIG. 7 is a schematic top view showing the heating regions and quenching regions formed respectively by the laser beams and quenching nozzles according to a further embodiment of the present invention.

FIGS. 8A-8D illustrate the separation process for a nonmetallic substrate where the separation results in an imperfect cut or soge.

FIGS. 8E-8H illustrate the separation process for a nonmetallic substrate where the separation results in a right angle cut.

FIG. 9A shows a schematic view of a nonmetallic substrate separation apparatus including a crack sensor according to a further embodiment of the present invention.

FIG. 9B shows another schematic view of the nonmetallic substrate separation apparatus including a crack sensor according to the further embodiment of the present invention.

FIG. 10 illustrates a cutting order for a laminated nonmetallic substrate according to a further embodiment of the present invention.

FIG. 11 illustrates a different cutting order for a laminated nonmetallic substrate according to another embodiment of the present invention.

FIG. 12 schematically illustrates a cutting order for CF side cutting according to the embodiment shown in FIG. 11.

FIG. 13 is a schematic perspective view showing the nonmetallic substrate being disposed on a movable table.

FIG. 14 is a schematic overall drawing of the nonmetallic substrate separation apparatus including a crack sensor for control according to a further embodiment of the present invention.

FIG. 15 is a flowchart showing the control process using the crack sensor to control crack propagation in the nonmetallic substrate according to the present invention.

### DETAILED DESCRIPTION OF THE PREFERRED EMBODIMENTS

Herein below, the embodiments of the present invention are described with reference to the accompanying drawings.

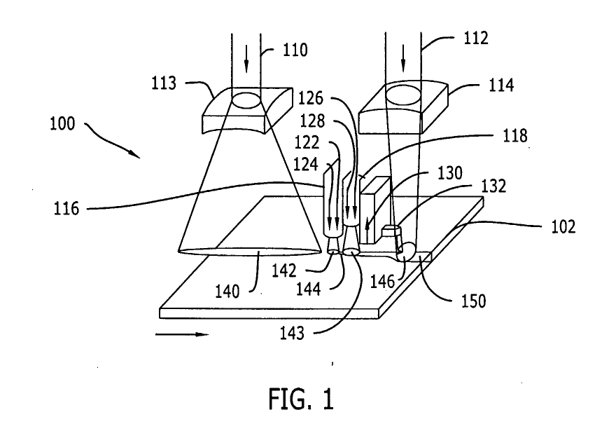

FIG. 1 is a schematic overview of an apparatus for separating nonmetallic materials according to the present invention. The separating apparatus generally indicated by reference numeral 100 for separating a nonmetallic material 102 includes two laser beams 110 and 112 and at least two quenching nozzles 116 and 118.

The nonmetallic substrate 102 is moved along relative to the separating apparatus 100 in the direction shown by the arrow below the nonmetallic substrate 102, such as glass. The laser beam 110 passes through a lens 113 and focuses to a scribe laser beam heating region 140. The two quenching nozzles 116 and 118 are shown schematically as forming quenching zones 142 and 143, respectively on the nonmetallic substrate 102. Between the quenching zones 142 and 143 is a propagated scribe line 144. The laser beam 112 passes through a lens 114 and focuses on a break laser beam heating region 146. Separation of the nonmetallic substrate 102 is controlled along an actual cut line 150.

Each of the quenching nozzles includes a passageway for passing a gas or liquid 122 and 126, respectively. For example, passageways 122 and 126 can supply water to the nonmetallic substrate 102. Optionally, the nozzles 116 and 118 can include a further passageway 124 and 128, respectively, for supplying a second gas and/or liquid. For example, the further passageways 124 and 128 can supply air to the nonmetallic substrate 102. Thus at least two fluids or gases or a mixture can be supplied through each nozzle 116 and 118 for quenching the nonmetallic substrate 102.

Adjacent to the nozzle 118 is a vacuum nozzle 130 for removing the remaining quenching liquids through a passageway disposed therein. As shown in FIG. 1, the vacuum nozzle 130 has an approximately rectangular cross-section. A shutter 132 is disposed as shown schematically adjacent to the vacuum nozzle 130. The shutter 132 can be used to selectively block a portion of the break laser beam 112 to effectively shortened the beam spot on the workpiece. The shutter 132 can also be used to change the beam length during the laser cutting process.

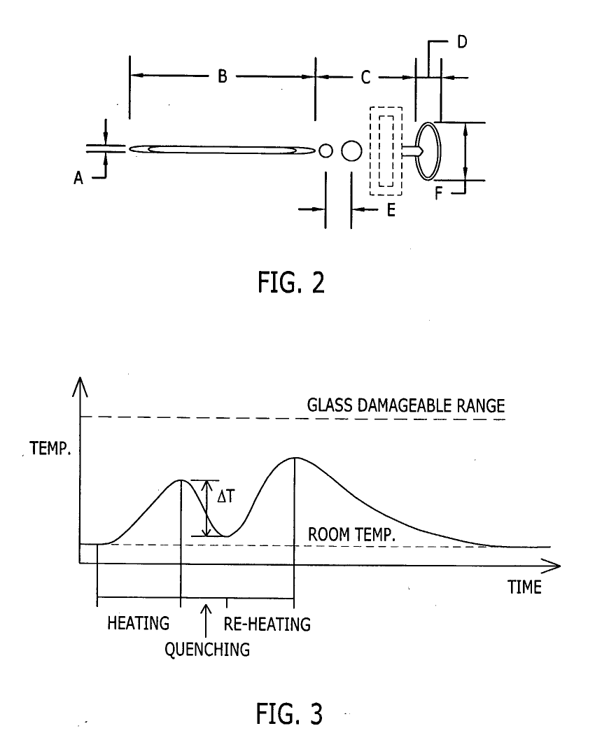

FIG. 2 illustrates an overall top view of the cutting and quenching processes shown in FIG. 1 with the separating apparatus 100 being removed for clarity. The scribe laser beam heating region 140 includes a controllable width A and a length B. The distance between the scribe laser beam heating region 140 and the reheating region 146 is represented by a distance C can also be charged. A length D and a width F of reheating region 146 are also controlled. The present invention also controls and adjusts the distance E between the quenching zones 142 and 143. Typically the following ratio of sizes of A:B:C:D:E:F is useful: 0.5:55:35:8:5:10.

FIG. 3 shows a temperature vs. time graph of the heating of the nonmetallic substrate 102. The nonmetallic substrate 102 is initially heated from room temperature as it proceeds to pass the initial scribe laser beam and then it passes through the two quenching zones 142 and 143. This is followed by a heat gain caused by the break laser beam 112 and with full or partial separation occurring followed by cooling to room temperature.

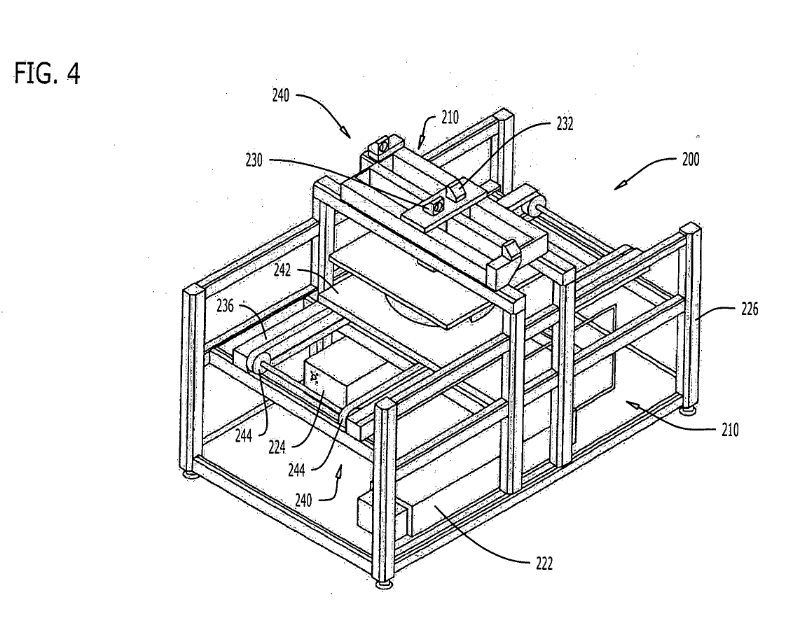

FIG. 4 illustrates the major components of the present invention for a full material separation laser system and is generally shown by reference numeral 200. The system includes single or multiple laser sources and associated options, forming an optical system, indicated generally by reference numeral 210. The optical system 210 includes two lasers 222 and 224, which are supported on a machine frame 226. A motion system 240 includes a support table 242 that traverses the frame belt drive mechanism 244 and moves the workpiece relative to the optical system 210 formed by the lasers 222 and 224. The lasers form two (or more) beam paths. The system includes an integrated cleaving device (ICD) and a vending mirror for the scribing beam 230 and a vending mirror for the breaking beam 232. Also, the laser beam 110 (not shown) irradiated from the laser 222 can be impinged on the mirror 230. Further, the laser beam 112 (not shown) irradiated from the laser 224 can be impinged on the mirror 232.

The motion system 240 uses a computer controller 236 to control movement of the workpiece relative to the laser output. The computer controller 236 is shown adjacent to the frame belt drive mechanism 244 although the computer controller can be disposed at a remote location. One possible control method generates control signals from the computer to move the workpiece in the x, y and rotational directions while holding the optics stationary. Conversely, the workpiece can remain stationary, while the optical system carrying the laser is moved in all directions. A hybrid approach allows both the optical system and the workpiece to be moved in limited directions. By rotating the optical system 180 degrees, bidirectional cutting is possible. It is also possible to cut on both the top and bottom side of the material by placing the workpiece on a process table with slots underneath any desired cuts. The process table can also facilitate breaking when a roller breaking device is placed underneath the workpiece.

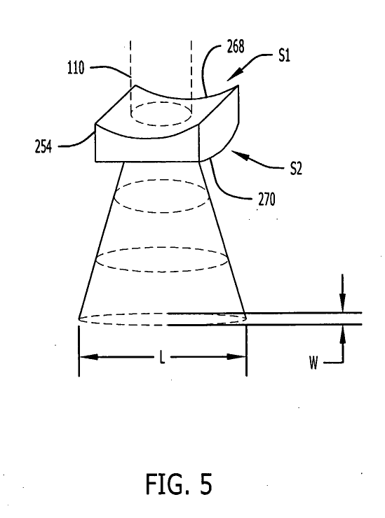

FIG. 5 discloses the use of a Double Asymmetric Cylindrical Lens Element (DACLE) 254. The curved “concave” surface (S1) 268 is configured to have an optimum negative focal length to control the beam length (L) and the energy distribution in the direction of the cut. The opposite curved “convex” surface (S2) 270 is configured to have an optimum positive focal length and control the beam's width (W) and its energy distribution orthogonal to the cut direction.

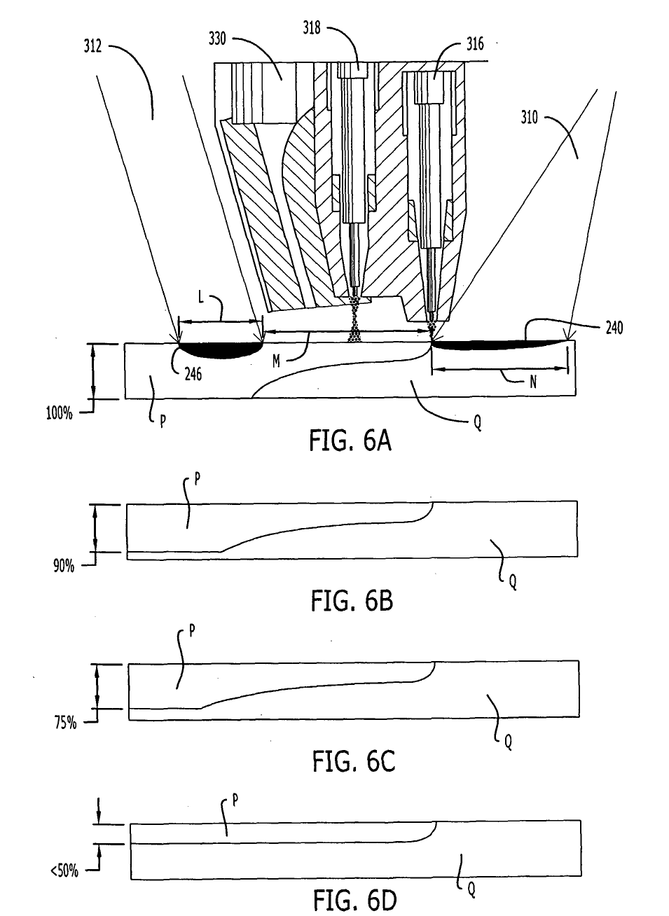

FIG. 6A discloses a schematic drawing of another embodiment of the present invention including laser beams 310, 312 and quenching nozzles 316 and 318. The vacuum nozzle 330 is also shown adjacent to the nozzle 318 to gather any remaining quenching liquids from the surface of the nonmetallic substrate prior to the second beam 312 contacting the nonmetallic substrate in a heating region 246.

Control of the separating apparatus includes monitoring and regulating the size L of the heating region 246, the distance M between the end of the scribe laser beam heating region and the beginning of the heating region 246 and the length N of the scribe laser beam heating region 240.

FIG. 6A shows an arrangement where full 100 percent separation is accomplished with the separating apparatus. The region P is the region which has not separated and the region Q is the region which has separated. In this example, the laser beam 312 is operated at 200 watts.

FIG. 6B illustrates 90 percent separation being accomplished by varying the control parameters as discussed above. For example, the laser beam 312 can be operated at 175 watts.

FIG. 6C illustrates 75 percent separation which is accomplished by varying the control parameters, for example operating the laser beam 312 at 150 watts.

FIG. 6D shows an example where no break beam 312 is used. In this example, a 130-180 micron vent is produced from thermal shock and crack propagation.

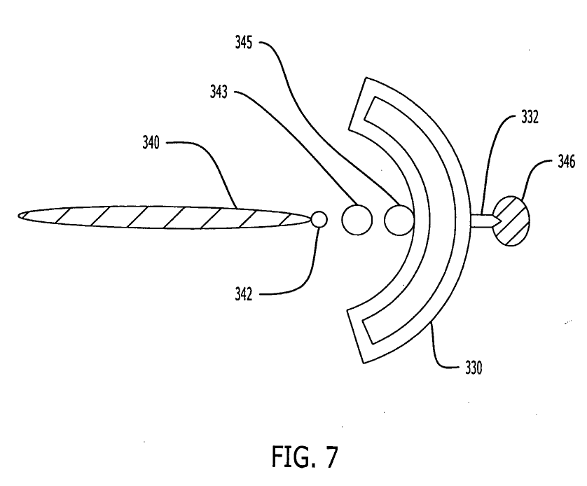

FIG. 7 shows another embodiment using a device similar to the one used in FIG. 6A. A scribe laser beam heating region 340 is shown on the left side of the FIG. 7. Adjacent thereto or partially overlapping therewith is a first quenching region 342 which is supplied by a first quenching nozzle. Spaced from the first quenching region 342 is a second quenching region 343 which is supplied by a second quenching nozzle and spaced from the second quenching region 343 is an optional third quenching region 345 supplied by an optional third quenching nozzle (not shown).

A vacuum removal area 330 is disposed adjacent to the third quenching region 345 for removing any quenching liquids which remain on the nonmetallic substrate. In this embodiment, the vacuum removal area has an arc shape so that it can remove any liquids which may have scattered on either side of the cut line during quenching. A shutter 332 is disposed adjacent the vacuum removal nozzle for allowing the break laser beam to be adjusted according to the techniques described above. A break beam heating region 346 is also shown and this region operates to complete the separation of the nonmetallic substrate depending on its settings.

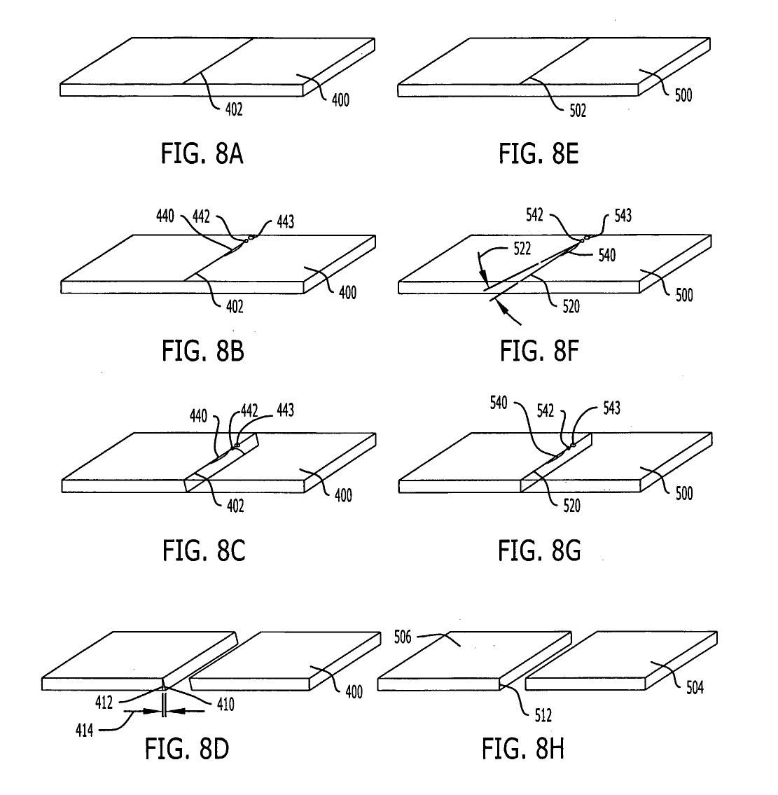

FIGS. 8A-8D illustrate the cutting steps used in the prior art which often produce a soge cut (a cut not at right angles). FIG. 8A shows the nonmetallic substrate 400 included a required scribe line 402. FIG. 8B illustrates the beginning laser beam heating process and shows the scribe laser beam forming a heating region 440 and the quenching nozzles forming quenching regions 442 and the break laser beam forming a heating region 443. As the separation process continues and due to the uneven heating process in the nonmetallic substrate, the scribe laser beam heating region 440 tends to be arranged so that it is not symmetric with the cut line. This causes the separation between the nonmetallic substrate portions to a deviate from a true right angle cut. FIG. 8D shows the result of such a separation of the nonmetallic substrate 400. The side edge 410 of the cut is angled from the desired side edge line 412 such that a distance between the side edge 410 and the desired side edge 412 on the bottom side of the nonmetallic substrate 400 is shown by a distance 414.

FIGS. 8E-8H illustrate the cutting steps used in the present invention to produce a right angle side edge cut for both pieces. FIG. 8E shows the nonmetallic substrate 500 including a required scribe line 502. FIG. 8F illustrates the beginning laser beam heating process and shows the scribe laser beam forming a heating region 540 and the quenching nozzles forming quenching regions 542 and 543. According to the present invention, it is possible to determine the crack propagation and direction using a device such as a crack sensor, which will be described in further detail below. Based on the determination of the progress of the crack propagation and the direction of the crack propagation, the present invention adjusts the laser beam angle, energy distribution and/or the direction of the scribe laser beam so as to compensate and correct the direction of crack propagation during the separation process. For example, the original desired cut line direction is shown by line 520 and the direction of the scribe laser beam can be reoriented along line 522 for some time so that the crack propagation and can be corrected to continue along the line 520. FIG. 8G shows the laser beam separating process continuing along the corrected path 520 for separation of the nonmetallic substrate 500. FIG. 8H shows the completed separation process where the nonmetallic substrate has been separated into two pieces 504 and 506. Each of the pieces 504 and 506 include side edges that are cut at right angles. The nonmetallic substrate 506 includes a side edge 512 which has been formed to be perpendicular to the top and bottom edges of nonmetallic substrate 506.

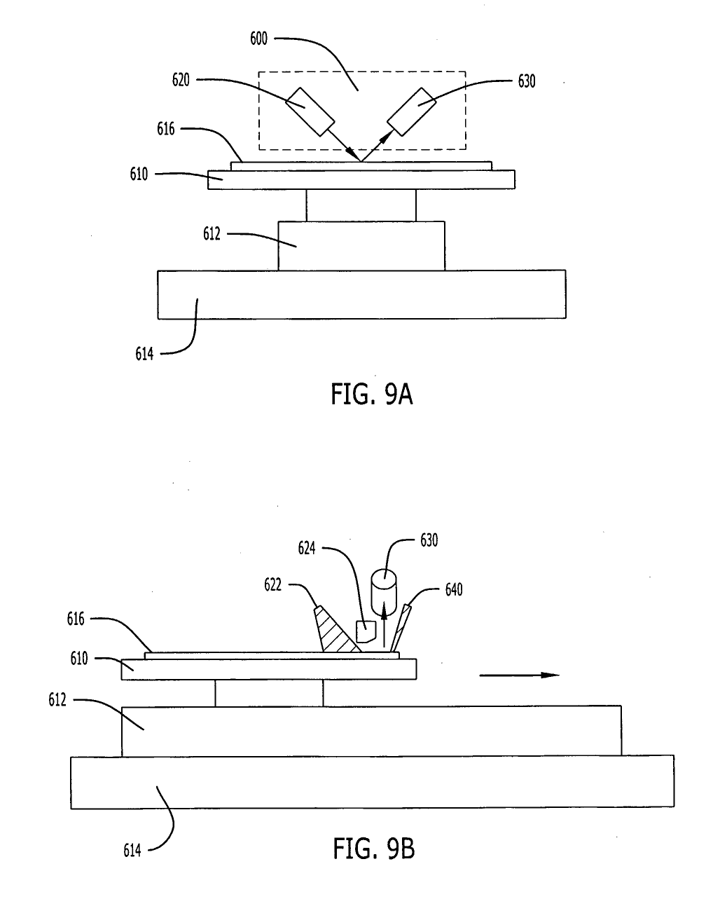

FIGS. 9A and 9B illustrate front and side views of the separating apparatus according to another embodiment of the present invention. The separating apparatus includes a laser cutting unit 600 disposed above a process table 610. The process table 610 is moved in a linear direction by a linear motor 612. The linear motor 612 is disposed on a base 614 of the separating apparatus. A nonmetallic substrate 616 is disposed on the process table 610.

The laser cutting unit 600 includes a light source 620 for generating a light beam which can be directed at the crack propagating through the nonmetallic substrate 616. A light is reflected by the nonmetallic substrate 616 and can be received by a crack sensor 630. Many different types of crack sensors can be used as described above.

FIG. 9B shows a side view of the laser cutting unit including illustrating a scribe beam 622, nozzle or nozzles 624 and a break beam 640 with the light source 620 (not shown) and the crack sensor 630 being disposed so as to receive light between the quenching nozzle(s) 624 and the break beam 640.

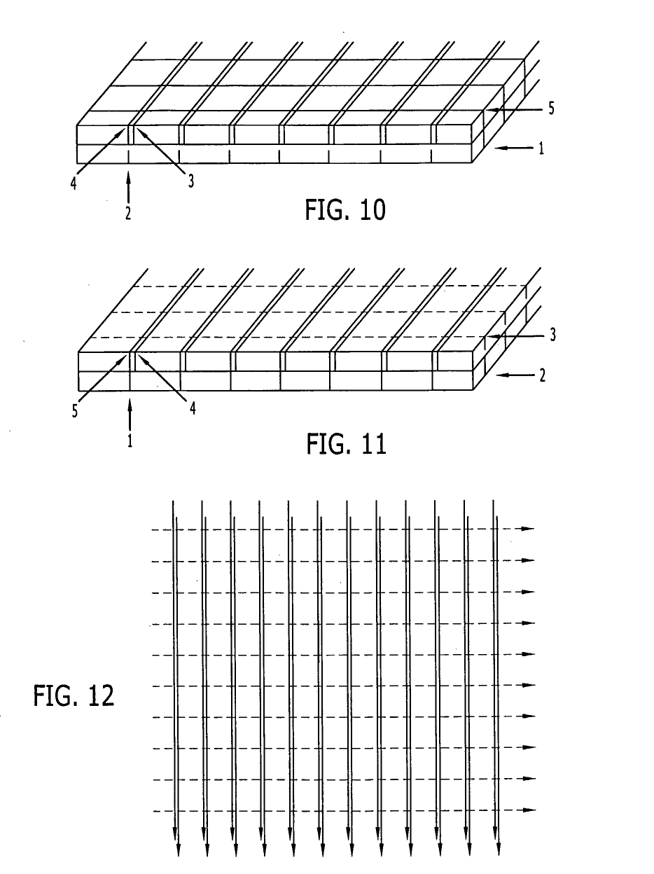

FIG. 10 illustrates cutting order for a laminated glass substrate according to the present invention. For example, if the laminated glass includes a TFT panel in the laminated substrate, then this panel can be cut first. The first and second cuts are full cuts along lines 1 and 2. It is possible to vary the laser power during these cuts. Then the laminated glass substrate can be cut on the color filter (CF) side by performing a full offset cut along line 3 followed by a full cut along line 4 and a full cut along line 5.

FIG. 11 illustrates another cutting order for a laminated glass substrate according to the present invention. For example, if the laminated glass includes a TFT panel in the laminated substrate, then the first and second cuts are full cuts along lines 1 and 2 in the TFT panel. Then the laminated glass substrate can be cut on the CF side by performing a scribe cut along line 3 followed by a full of said the along line 4 and a full/half cut along line 5. FIG. 12 shows the CF side cutting procedure. It is also possible to adjust the cutting speeds during these cutting procedures.

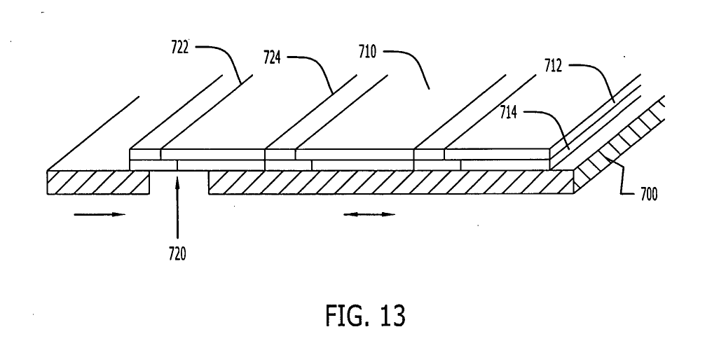

FIG. 13 shows in a metallic substrate such as a glass or other panel 710 disposed on a movable table 700. The movable table can be separated into various sections allowing cut lines to be formed from the rear side of the nonmetallic substrate 710. In this example, the laminated panel includes a TFT panel 712 and a color panel 714 which have been joined together by an adhesive. As shown in FIG. 13, it is possible to make a first cut along line 720 in the region between the space edges of the movable table 700. Additional cuts can then be made along cut lines 722 and 724.

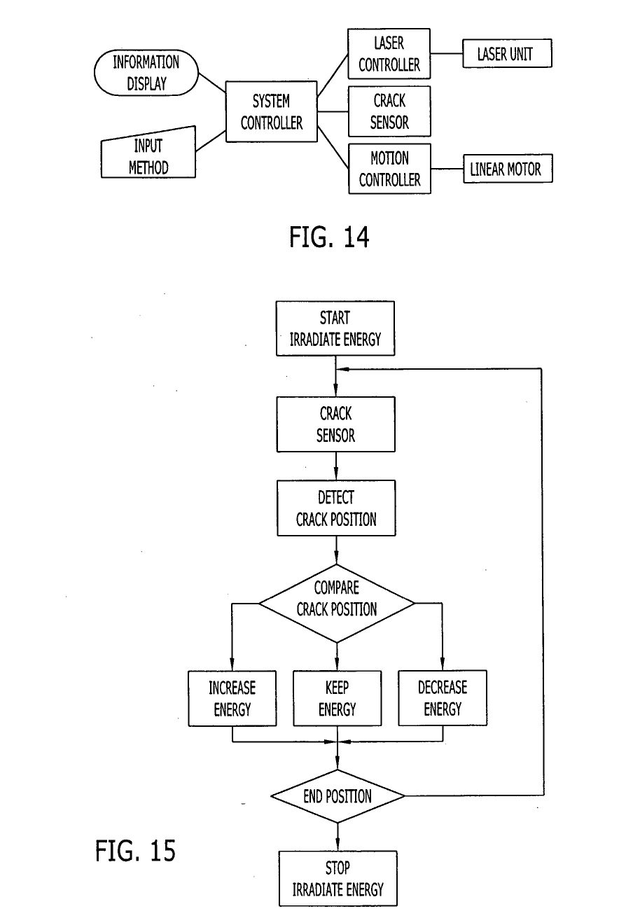

FIG. 14 discloses an overall schematic view of the control mechanism for the separating apparatus according to the embodiment including a crack sensor. The system controller includes connections to an information display, and an input method such as a keyboard, a laser controller for laser controllers for controlling the laser units, a crack sensor and a motion controller for controlling the linear motor.

FIG. 15 illustrates a flowchart for a control procedure using the crack sensor according to the present invention. Initially the laser beam radiation starts impacting on the nonmetallic substrate. Then the crack sensor light source initiates and the light rays reflected from the nonmetallic substrate indicating the crack growth and direction and the crack sensor detects them. A comparison is then done to compare the desired crack propagation position and direction with the measured crack propagation position and direction. If the desired position and the measured position are the same, then the energy level is maintained at its current setting. However if the measured position of the crack propagation is ahead of the desired position than the energy to the laser is decreased. Alternatively, if the measured position of the crack propagation is a behind the desired position then energy to the laser is increased. This process continues until the end position of the nonmetallic substrate is reached. When the end position of the nonmetallic substrate is obtained then the energy for the laser beams are stopped.

Optimum sequence of cutting has been developed for a number of applications including cell phone cutting and sleeve cutting of HDTV panels. For cell phone applications, by being able to control the depth of the cut (e.g. 90% cuts) on the first side that one cuts, one can more easily achieve reliable cross cutting of cell phone work of the panels because the panel is held together during the cutting of the second side of a laminated panel. The edge effects of the second cuts (e.g. and entry and exit areas) by dynamically controlling the laser power, x-y position (e.g. “jogging”), table angle, crack initiation force and position (for entry), and table vacuum force to achieve the desired result.

It is also possible to use plural beams to generate the proper balance of thermal shock to make a blind crack and subsequently generate enough tensile force by the application of the second beam to fully or partially cut the single or laminated panel. A vacuum is used to remove any residual water or fluid used for quenching preventing any exposure of the optical surfaces (such as the mirrors, lenses, etc.)

Independent control of the first lasers (scribe beam) and the second laser (break beam) are also possible. Computer software is used to dynamically control the laser beam power and/or angle of the table with respect to the laser beams and/or the speed of the table throughout the process to control and stabilize the crack propagation through the panel.

Real-time closed loop control of the blind crack depth (e.g. from 1 percent to 100 percent separation) by varying the laser power on the second laser. This power is controlled by a feedback loop from a crack sensor or detector that can measure the presence and/or with of the crack or a vent depth detection device (optical, sonic, RF, or other methods). This will enable us to precisely control the depth of the cut and/or manage the full cutting position and profile of the resultant separated glass in situ.

The configuration of the plural nozzle beams include two or more nozzles that are used to enhance cooling/quenching of the brittle material. The nozzles are designed for maximum quenching (dT/dt) over a small footprint (e.g. <0.5 mm diameter) and/or maximum overall heat removal (cooling effect or dQ/dt). By creating a deeper vent or blind crack, it is possible to reduce the force and hence the power required to fully separate the material or panel.

It is to be understood that although the present invention has been described with regard to preferred embodiments thereof, various other embodiments and variants may occur to those skilled in the art, which are within the scope and spirit of the invention, and such other embodiments and variants are intended to be covered by the following claims.

What is claimed is:

1. An apparatus for separating a portion of a nonmetallic substrate, comprising:
a first beam, the first beam impinging on the substrate at a first spot, the first spot having a leading end and a trailing end;
a first quenching device, said first quenching device positioned so that a coolant stream may be applied to the substrate at or immediately adjacent to the trailing end of the first spot;
a second beam, the second beam impinging on the substrate at a second spot, the second spot positioned on the substrate behind the first spot; and
a second quenching device, said second quenching device positioned between said first quenching device and said second beam.

2. An apparatus for separating a nonmetallic substrate as defined in claim 1, further comprising:
a third quenching device, said third quenching device positioned between said second quenching device and said second beam.

3. An apparatus for separating a nonmetallic substrate as defined in claim 1, wherein at least one of said first quenching device and said second quenching device includes an atomizing nozzle having a two fluid mixture.

4. An apparatus for separating a nonmetallic substrate as defined in claim 3, wherein the two fluid mixture includes water and air.

5. An apparatus for separating a nonmetallic substrate as defined in claim 1, further comprising means for independently adjusting parameters of said first quenching device relative to said second quenching device.

6. A method of controlling separation of a portion of a nonmetallic substrate, comprising the steps of:
impinging a first beam on the substrate at a first spot, the first spot having a leading end and a trailing end;
quenching with a first quenching nozzle positioned so that a coolant stream may be applied to the substrate adjacent to or spaced from a heat affected zone;
further quenching with a second quenching nozzle positioned adjacent to and spaced from the first quenching nozzle; and
impinging a second beam onto the substrate at a second spot to break through a portion of a thickness of the substrate.

7. The method of controlling separation of a portion of a nonmetallic substrate as defined in claim 6, further comprising the step of:
providing additional quenching with a third quenching nozzle positioned adjacent to and spaced from the second quenching nozzle.

8. The method of controlling separation of a portion of a nonmetallic substrate as defined in claim 6, further comprising the step of:
vacuuming excess quenching liquid prior to the second spot.

9. The method of controlling separation of a portion of a nonmetallic substrate as defined in claim 6, further comprising the step of:
providing at least one of the first quenching nozzle and the second quenching nozzle with an atomizing nozzle having a two fluid mixture.

10. The method of controlling separation of a portion of a nonmetallic substrate as defined in claim 6, further comprising the step of:
varying an amount of power supplied in the second beam.

11. The method of controlling separation of a portion of a nonmetallic substrate as defined in claim 6, further comprising the step of:
controlling parameters of the first quenching nozzle independently of the second quenching nozzle.

12. A method of making a right angle separation in a nonmetallic substrate, comprising the steps of:
impinging a first scribe beam on the substrate at a first spot, the first spot having a leading end and a trailing end;
quenching with a first quenching nozzle positioned so that a coolant stream may be applied to the substrate in a heat affected zone;
impinging a second beam onto the substrate at a second spot to break through a portion of a thickness of the substrate; and
adjusting at least one of an angle at which the first scribe beam impinges on the substrate and an energy intensity of the first scribe beam impinging on the substrate.

13. A method of making a right angle separation in a nonmetallic substrate as defined in claim 12, wherein said step of adjusting at least one of an angle at which the first scribe beam impinges on the substrate includes adjusting a position of a lens related to the first scribe beam.

14. A method of making a right angle separation in a nonmetallic substrate as defined in claim 12, wherein said step of adjusting at least one of an angle at which the first scribe beam impinges on the substrate includes adjusting a position of the first spot.

15. A method of making a right angle separation in a nonmetallic substrate as defined in claim 14, wherein said step of adjusting at least one of an angle at which the first scribe beam impinges on the substrate includes adjusting a position of the first spot by adjusting a position of a table holding the substrate.

16. A method of making a right angle separation in a nonmetallic substrate as defined in claim 14, wherein said step of adjusting at least one of an angle at which the first scribe beam impinges on the substrate includes adjusting the position of the first spot by adjustment of a mirror.

17. A method of making a right angle separation in a nonmetallic substrate as defined in claim 12, wherein said step of adjusting at least one of an angle at which the first scribe beam impinges on the substrate includes adjusting the position of the first spot by adjustment of a mirror.

18. A method of making a right angle separation in a nonmetallic substrate as defined in claim 12, wherein said step of adjusting at least one of an angle at which the first scribe beam impinges on the substrate includes adjusting a position of a table holding the substrate.

19. A method of separating a nonmetallic substrate, comprising the steps of:
impinging a first beam on a first side of the substrate at a first spot;
quenching with a first quenching nozzle positioned so that a coolant stream may be applied to the first side of the substrate;
impinging a second beam onto the substrate at a second spot to break through a portion of a thickness of the substrate;
rotating the substrate so a second side of the substrate is facing the first beam, the first quenching nozzle and the second beam;
impinging the first beam on the second side of the substrate at a third spot;
quenching with the first quenching nozzle positioned so that a coolant stream may be applied to the second side of the substrate; and
impinging the second beam onto the substrate at a fourth spot to break through at least another portion of the thickness of the substrate.

20. A method of separating a nonmetallic substrate as defined in claim 19, further comprising the step of:
quenching with a second quenching nozzle positioned between said first quenching nozzle and the second beam.

21. A method of separating a nonmetallic substrate as defined in claim 19, wherein said step of impinging a second beam onto the substrate forms an approximately half cut through the first side of the substrate and said step of impinging the second beam onto the second side of the substrate forms a full cut through the substrate.

22. An apparatus for separating a portion of a nonmetallic substrate, comprising:
a first beam, the first beam impinging on the substrate at a first spot, the first spot having a leading end and a trailing end;
a first quenching device, said first quenching device positioned so that a coolant stream may be applied to the substrate at or immediately adjacent to the trailing end of the first spot;
a second beam, the second beam impinging on the substrate at a second spot, the second spot positioned on the substrate behind the first spot for forming a cut line in the substrate;
a crack sensor separated from the substrate for measuring a position of the cut line; and
a controller operatively connected to said crack sensor for receiving information about the position of the cut line and comparing the position of the cut line with a reference position, and said controller including means for adjusting the power intensity of the second beam based on the comparison of the position of the cut line with the reference position.

23. An apparatus for separating a portion of a nonmetallic substrate as defined in claim 22, wherein said crack sensor includes at least one of a CCD sensor, a CMOS sensor, an acoustic sensor, an image sensor and an ultrasonic sensor.

24. An apparatus for separating a portion of a nonmetallic substrate as defined in claim 22, wherein said means for adjusting the power intensity of the second beam includes decreasing the power intensity if the cracking position is ahead of the reference position.

25. An apparatus for separating a portion of a nonmetallic substrate as defined in claim 22, wherein said means for adjusting the power intensity of the second beam includes increasing the power intensity if the cracking position is behind the reference position.

26. A method of adjusting a separation process of a nonmetallic substrate, comprising the steps of:
impinging a first beam on the substrate at a first spot;
quenching with a first quenching nozzle positioned so that a coolant stream may be applied to the substrate in a heat affected zone;
impinging a second beam onto the substrate at a second spot to break through a portion of a thickness of the substrate thereby forming a cut line in the substrate;
measuring a position of the cut line using a crack sensor;
comparing the position of the cut line with a reference position; and
adjusting the power intensity of the second beam based on the comparison of the position of the cut line with the reference position.

27. A method of adjusting a separation process of a nonmetallic substrate as defined in claim 26, wherein said step of adjusting the power intensity of the second beam includes decreasing the power intensity if the cracking position is ahead of the reference position.

28. A method of adjusting a separation process of a nonmetallic substrate as defined in claim 26, wherein said step of adjusting the power intensity of the second beam includes increasing the power intensity if the cracking position is behind the reference position.

29. A method of adjusting a separation process of a nonmetallic substrate as defined in claim 26, further comprising the step of continuing said steps of measuring, comparing and adjusting along an entire length of the cut line.

30. A method of adjusting a beam shape during a separation process of a nonmetallic substrate, comprising the steps of:
impinging a first beam on the substrate at a first spot;
quenching with a first quenching nozzle positioned so that a coolant stream may be applied to the substrate in a heat affected zone;
impinging a second beam onto the substrate at a second spot to break through a portion of a thickness of the substrate thereby forming a cut line in the substrate; and
adjusting at least one of a shape of a first spot where the first beam impinges on the substrate and an energy density profile of the first beam so that there is a varying energy density profile of the first beam impinging on the substrate.

31. A method of adjusting a beam shape during a separation process of a nonmetallic substrate as defined in claim 30, wherein said step of adjusting includes adjusting the shape of the first spot to include an asymmetrical beam shape.

32. A method of adjusting a beam shape during a separation process of a nonmetallic substrate as defined in claim 30, wherein said step of adjusting includes adjusting the energy density profile of the first beam so that there is an asymmetrical energy density.

33. A method of adjusting a beam shape during a separation process of a nonmetallic substrate as defined in claim 30, wherein said step of adjusting includes adjusting the energy density profile of the first beam so that a center of the energy density profile is closer to one side of the first spot than another side.

34. A method of adjusting a beam shape during a separation process of a nonmetallic substrate as defined in claim 30, wherein said step of adjusting includes forming one portion of the first spot to be thinner than another portion of the first spot.

35. A method of adjusting a beam shape during a separation process of a nonmetallic substrate as defined in claim 30, wherein said step of adjusting includes forming a tilt angle between the substrate and a direction of the first beam.

36. A method of adjusting a beam shape during a separation process of a nonmetallic substrate as defined in claim 35, wherein said step of adjusting includes forming the tilt angle between the substrate and a direction of the first beam by adjusting a lens position forming the first beam.

37. An apparatus for adjusting a beam shape during separation of a nonmetallic substrate, comprising:
a first beam, the first beam impinging on the substrate at a first spot, the first spot having a leading end and a trailing end;
a first quenching device, said first quenching device positioned so that a coolant stream may be applied to the substrate at or immediately adjacent to the trailing end of the first spot;
a second beam, the second beam impinging on the substrate at a second spot, the second spot positioned on the substrate behind the first spot for forming a cut line in the substrate; and
a controller means for adjusting a shape of the first spot produced by the first beam.

38. An apparatus for adjusting a beam shape during separation of a nonmetallic substrate as defined in claim 37, wherein said controller means includes means for adjusting the shape of the first spot into an asymmetrical beam shape.

39. An apparatus for adjusting a beam shape during separation of a nonmetallic substrate as defined in claim 37, wherein said controller means includes means for adjusting the energy density profile of the first beam into an asymmetrical energy density.

40. An apparatus for adjusting a beam shape during separation of a nonmetallic substrate as defined in claim 37, wherein said controller means includes means for adjusting the energy density profile of the first beam so that a center of the energy density profile is closer to one side of the first spot than another side.

41. An apparatus for adjusting a beam shape during separation of a nonmetallic substrate as defined in claim 37, wherein said controller means includes means for forming one portion of the first spot to be thinner than another portion of the first spot.

42. An apparatus for adjusting a beam shape during separation of a nonmetallic substrate as defined in claim 37, wherein said controller means includes means for forming a tilt angle between the substrate and a direction of the first beam by adjusting a lens position forming the first beam.
